(19) United States
(12) Patent Application Publication
(10) Pub. No.: US 2021/0233378 A1
(43) Pub. Date: Jul. 29, 2021

(54) Method and Assembly for Warning Against Hand to Face Contacts

(71) Applicants: Pedro A. Murati, Wichita, KS (US); Armando Mieses-Pelegrin, Santo Domingo (DO)

(72) Inventors: Pedro A. Murati, Wichita, KS (US); Armando Mieses-Pelegrin, Santo Domingo (DO)

(21) Appl. No.: 17/213,430

(22) Filed: Mar. 26, 2021

Related U.S. Application Data
(60) Provisional application No. 63/003,763, filed on Apr. 1, 2020.

(51) Int. Cl. G08B 21/24; G06K 7/10; G06K 7/08; G06K 19/077; G06K 19/07

(52) U.S. Cl. CPC G08B 21/245; G06K 7/10396; G06K 19/0723; G06K 19/07762; G06K 7/084

(57) ABSTRACT

An assembly for warning of hand to face contacts, the assembly incorporating a radio frequency identification system reader; a case enclosing the radio frequency identification system reader, the case being configured as a wearable item selected from the group consisting of necklace segments, necklace pendants, brooches, pins, hair ornaments, hats, clasps, and tie slides; a first radio frequency identification system data signaling tag; and a first jewelry item selected from a group consisting of bracelets, wristwatches, and rings; wherein the radio frequency identification system data signaling tag is fixedly attached to an undersurface of the selected first jewelry item.

### CLAIM OF PRIORITY FROM PREVIOUSLY FILED PROVISIONAL PATENT APPLICATION

This non-provisional patent application claims the benefit of and priority from U.S. Provisional Patent Application No. 63/003,763 filed Apr. 1, 2020. The inventor disclosed in and applicant of said provisional application is the same person as the person who is disclosed as the inventor in and applicant of the instant application. The applicant asserts that structures and functions of structures disclosed and described in the instant application are substantially identical to those disclosed in said provisional application.

### FIELD OF THE INVENTION

This invention relates to apparatus, assemblies, methods, and processes which are adapted for reminding a person to keep his or her hands away from his or her face, or for warning against such actions. A facial contact with one's hands is a known means of pathogen transfer, and this invention relates to electronic means for warning against and preventing such pathogen transfers.

### BACKGROUND OF THE INVENTION

On many occasions, a person may place his or her hand in contact with his or her face. For example, the person may rest his head upon his hand while thinking or resting. Also, many common non-verbal gestures include the act of touching a hand to one's face. Acts such as scratching an itch or shooing away a fly also commonly result in a contact of a person's hand with his or her face. Such hand to face contacts are known to transfer pathogens from a person's fingers to the areas of the person's mouth, nose, and eyes, undesirably infecting the person with viral or bacterial diseases. Such knowledge of pathogen transmission may lead a person to try to remember not to touch his or her face. However, face touching often occurs substantially involuntarily, and memory based strategies for avoiding facial touching are often ineffective.

The instant inventive method and assembly provides a useful electronically generated warning signal immediately prior to such hand to face contacts through the use of radio frequency identification or RFID technology, advantageously lessening the risk of hand to face transmission of pathogens.

### BRIEF SUMMARY OF THE INVENTION

A first structural component provided as a part of the instant inventive method and assembly preferably comprises a reader component of a radio frequency identification (RFID) system. In a preferred embodiment, the provided reader component constitutes an active reader half of an ARPT or active reader passive tag RFID system. Microcircuitry incorporated into the active reader half of the system generates and transmits radio signals in the form of an RFID interrogator signal, and such reader has the capacity for receiving authenticating radio signal replies which are initiated by an RFID tag which resides within and moves relatively with respect to the interrogator signal. In the preferred embodiment, the reader unit is adapted to transmit an interrogator signal in the range of approximately 13 megahertz which facilitates passive RFID tag actuations in the range of six inches to twelve inches.

In the preferred embodiment, the RFID reader component is operatively housed within a hermetically sealed and water proof case that is small enough to be worn as a jewelry or ornamental item at or about a user's head, face, neck, or shoulder top area.

In a preferred embodiment, the case which contains and constitutes a part of the RFID reader component constitutes a segment of a necklace, or a necklace pendant. Alternatively, the case which comprises the reader may be configured as a brooch which may be pinned or clipped to a clothing item such as a collar near a user's neck, a head band, a scarf, a hair ornament, a hat or a cap. Further alternatively, the RFID reader may be incorporated as an integral part of head wear clothing items such as ball caps. Suitably, the RFID reader's case component may be configured for function as a scarf clasp or as the sliding ornament of a bolo tie.

In the preferred embodiment, the case which contains and houses the RFID system's reader component further supports and houses internal rechargeable lithium batteries, an integrated circuit digital processor, an operatively connected transmitter for generating a radio frequency alternating current, and an operatively connected antenna for producing interrogating radio waves from such current and for receiving RFID tag generated radio signal data packet replies. An electronic vibrating unit, a speaker, a LED lamp and/or manually depressible on/off buttons or input controls may also be incorporated as a part of the system's RFID reader unit.

A further structural component provided as a part of the instant inventive system comprises an RFID data signaling microchip or tag. Such tag component preferably incorporates within its microcircuitry a radio transponder which acts as an input radio signal receiver (for receiving the above described interrogating radio signals generated by the RFID reader unit), and as a generator of a differing electronic signal in the form of a digital data packet, such signal being transmitted in response to the interrogator radio signal.

In a preferred embodiment, the RFID tag component constitutes a passive tag whose electronic power source constitutes an induced electric current resulting from relative movement of the RFID tag through the interrogating radio waves which are transmitted by the reader unit. The RFID tag component may be affixed to an item of jewelry which is worn at the hand or wrist area such as a bracelet, a wristwatch, or a ring. In a preferred embodiment, two of such items of jewelry are provided, one to be worn at the wrist and hand area of one hand, and the other worn at the wrist and hand area of the user's other hand. Each such item of jewelry necessarily includes its own attached or incorporated RFID tag.

In a preferred embodiment, the RFID tags are attached to undersurfaces of the jewelry items, such as an inner surface of a bracelet ornament or the back of a wristwatch's case. Suitably, the RFID tags may be integrally incorporated into items of hand, wrist, or finger worn jewelry, effectively causing the entireties of such jewelry items to constitute a RFID tag halves of the inventive system.

In operation of the instant invention, and assuming that the RFID reader half of the system comprises a necklace or necklace pendant, one of the assembly's preferably passive RFID tags may be attached to a wristwatch worn about one of the user's wrists. A second tag may be attached to a bracelet worn about the user's other wrist. The user, while wearing the system's components, may actuate an on/off power button supported upon the exterior of the case of the RFID reader. Such actuation causes the reader unit to continuously emit interrogator radio signals, such signals being powered by the reader unit's on board rechargeable lithium batteries.

In the event that the user thereafter moves one of his or her hands to a location as close as one foot from his or her face, magnetic induction generated by movement of the wrist or hand mounted jewelry item's attached RFID tag through the field of interrogator signal produces an induced microcircuit powering electrical current. Thus powered, the RFID tag functions as a radio transponder which generates and transmits its own digital signal data. Such data is substantially instantly read by the microcircuitry of the RFID reader. Such circuitry substantially instantaneously actuates the RFID reader unit's on board buzzer, electronic vibrating unit, or LED lamp. In a suitable embodiment, the auditory signal may, as an alternative to a buzzing or beeping sound, may constitute vocal or synthesized speech which warns the user to move his or her hand away from the facial area.

Upon an actuation of the instant inventive assembly resulting from relative movements of system's halves into close proximity with each other, (i.e., where the RFID tag and RFID reader components closely approach each other), the user beneficially perceives a vibratory, visual, and/or auditory signal which reminds the user that one of the user's hands has come into an excessively close proximity with the user's face. In response to such signal, the user is advantageously reminded to move his or her hand away from the face prior to making facial contact.

In a suitable alternative configuration of the instant invention, two RFID reader units are provided in the form of bracelets, one worn at each of the user's wrist and hand areas. In such configuration, the system's RFID tag component may be housed and supported upon a jewelry item or clothing item worn at or about the user's head, facial, shoulder, or neck area.

Where the halves of the instant inventive system constitute a battery powered RFID reader half and a battery powered RFID tag half, the system constitutes an active tag RFID system. Such active tag variant of the system falls within the scope of the invention.

Accordingly, objects of the instant invention include the provision of a Method and Assembly for Warning Against Hand to Face Contacts which incorporates method steps and provisions of structures and assembly components, as described above, for the achievement of beneficial functions describe above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of a necklace configured RFID reader component of the instant invention.

FIG. 2 depicts a perspective view of a bracelet which may alternatively serve an RFID component of the instant invention.

FIG. 3 is a perspective view of an RFID tag retaining applique component.

FIG. 4 is a reverse view of the structure of FIG. 3.

FIG. 5 redepicts the structure of FIG. 4, the view further showing an inserted passive RFID microchip tag.

FIG. 6 redepicts the structure of FIG. 2, the view of FIG. 6 further showing an attachment of the FIG. 5 passive RFID microchip tag via the applique of FIGS. 3-5.

FIG. 7 is a magnified view of a portion of the structure of FIG. 6, as indicated in FIG. 6.

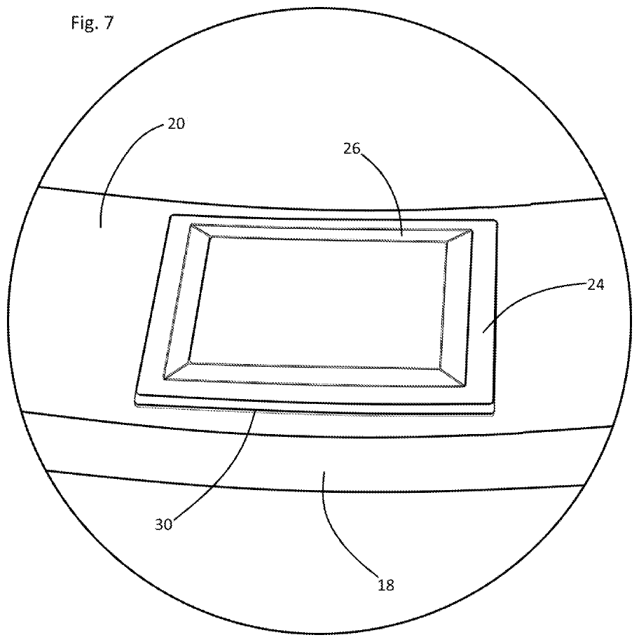

FIG. 8 depicts the structure of FIGS. 3-5 alternatively mounted to the back of a wristwatch.

FIG. 9 is a view of a person having the instant inventive system mounted at neck and wrist areas.

FIG. 10 presents alternative bracelet configurations of the structure depicted in FIG. 1.

FIG. 11 redepicts the person of FIG. 9, the view FIG. 11 showing the person wearing an alternative configuration of the instant inventive RFID system.

### DETAILED DESCRIPTION OF PREFERRED EMBODIMENTS

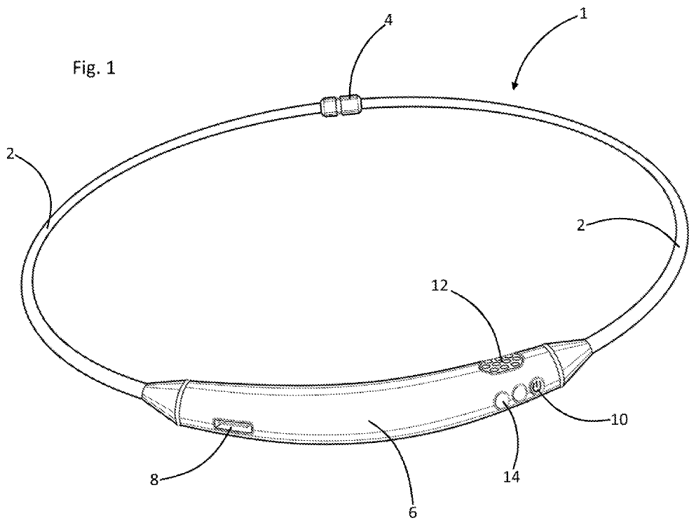

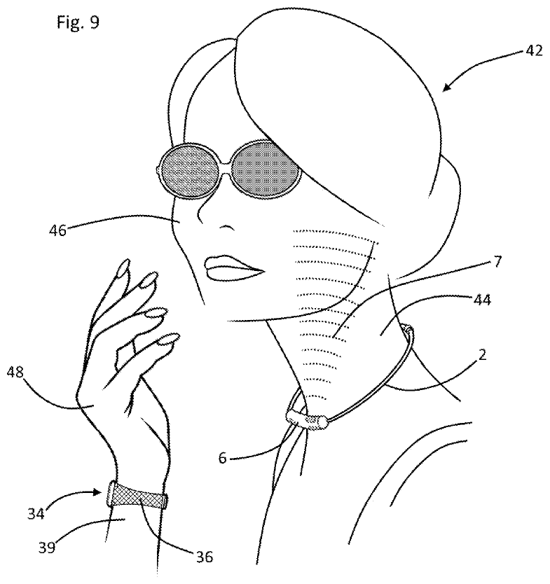

Referring now to the drawings and in particular to Drawing FIG. 1, a necklace configured RFID reader component of the instant invention is referred to generally by Reference Arrow 1. The necklace reader 1 incorporates a flexible loop 2 and has a tension releasable magnetic or snap fastened clasp 4. The releasable clasp 4 lessens choking and strangulation risks which may, referring to FIG. 9, arise from wearing loop 2 about a user's neck and throat 44.

The necklace configured RFID reader component 1 further incorporates within the loop 2 a hollow electronic component case 6, such case housing and encasing an electronic micro-circuitry enabled miniature RFID reader unit. A rechargeable lithium battery or batteries are additionally supported and housed within the case 6, such batteries providing continuous electrical power to the RFID reader component. A micro USB port 8 is provided for charging and recharging such batteries via a USB charging cable (not depicted within views). Components which are additionally powered by the internal rechargeable batteries include a speaker or buzzer 12 and an interior electronic vibrating unit. An on/off power button or switch 10 is provided for actuating and deactuating the RFID reader unit, and selector buttons 14 are provided for actuating and deactuating selected vibratory and auditory warning signal modes generated by the device.

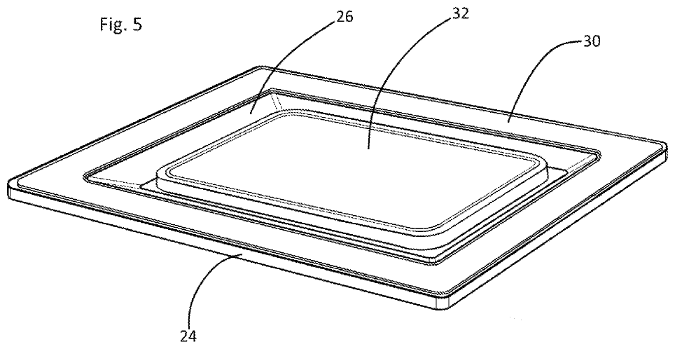

Referring to FIG. 5, an RFID tag 32 (suitably a passive tag) includes a hermetically sealed microchip which is adapted for generating electrical power via magnetic induction upon movement of the tag 32 through interrogating radio waves, such waves being emitted by the RFID reader unit 6. Upon its generation of such magnetically induced electrical power, the tag 32 acts as an RFID transponder which effectively transforms the power generating interrogation signal into a data signal which is returned to and is read by the RFID reader 6. Upon receipt of such returning RFID data signal, the RFID reader's microprocessor automatically actuates either the speaker/buzzer 12 or the vibrating unit which is housed within the RFID reader 6.

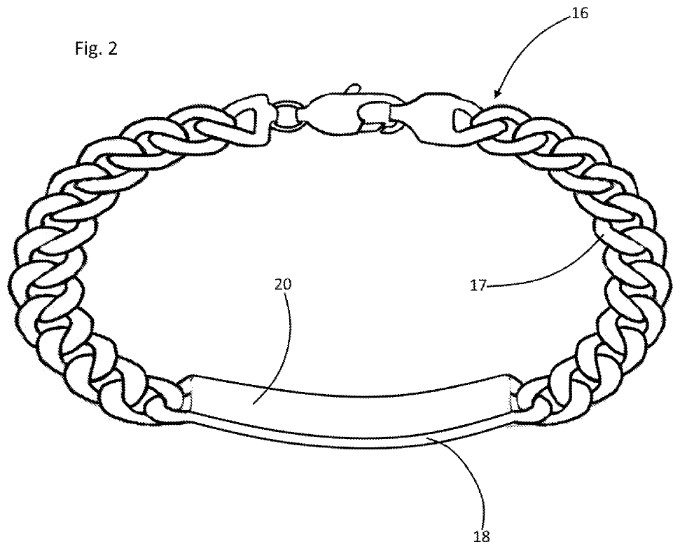

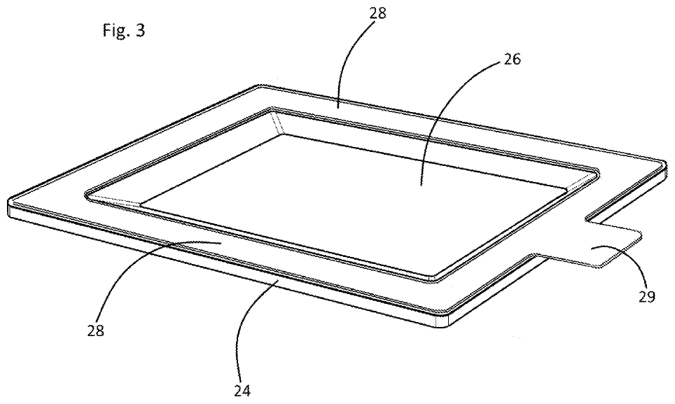

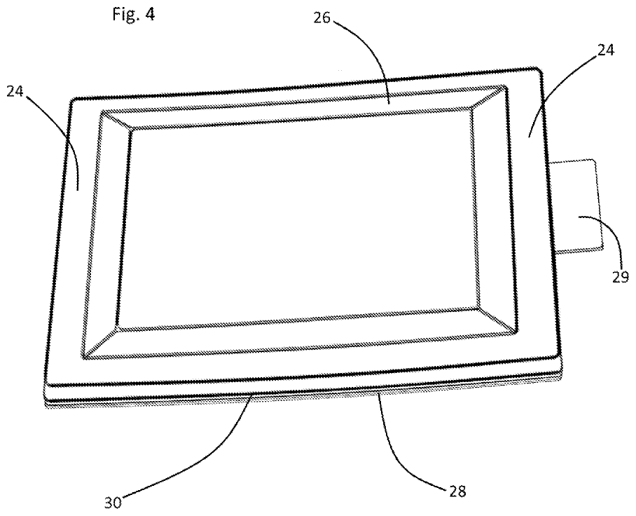

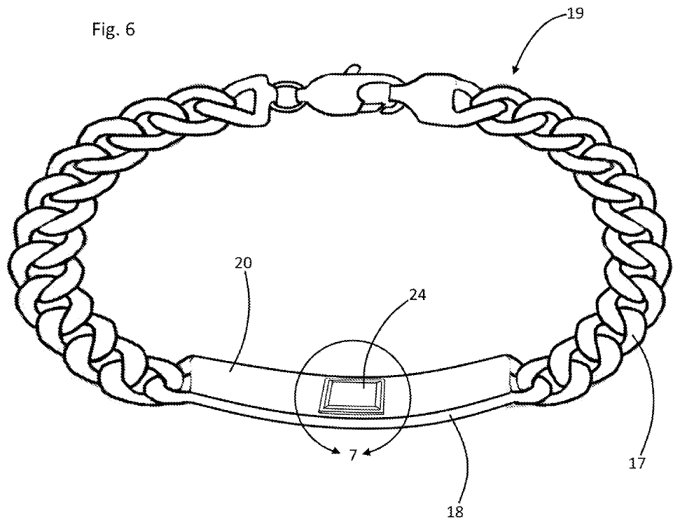

The RFID tag 32 may be initially inserted into and housed within a concavity 26 which is formed as a part of a retainer applique 24. Such applique 24 has a peripheral disposition of adhesive 30. In use of the applique 24, referring simultaneously to FIGS. 3-5, a user or operator of the instant invention may grasp the applique 24 and may pull upon tab 29 to remove an adhesive covering membrane 28 from the adhesive 30. Thereafter, referring further simultaneously to FIGS. 2 and 6, the applique and RFID tag assembly 24,32 may be inverted and may be pressed against the undersurface 20 of an ornament 18 of a jewelry item, such as a bracelet 16 which is worn at a user's hand or wrist area, such bracelet 16 having a wrist encircling loop 17.

Upon such applique 24 and RFID tag 32 adhesive attachment, the assembled bracelet 19 acts as an RFID tag component of the instant inventive system, such component performing radio signal transponding functions including receiving interrogating radio signals, and transmitting return data packet radio signals which electronically coordinate with and actuate the RFID reader component 1. Suitably, the RFID tag 32 may be alternatively directly adhesively attached to the undersurface of an ornament 18, or the RFID tag may be configured as an adhesively applied patch or label. Further alternatively, such tag may be formed as an integral component of such ornament. The ornament 18 is intended as being representative of all types of jewelry which is worn at fingers, hand and wrist areas such as finger rings, various types of bracelets, wristwatches, and smart watches and devices.

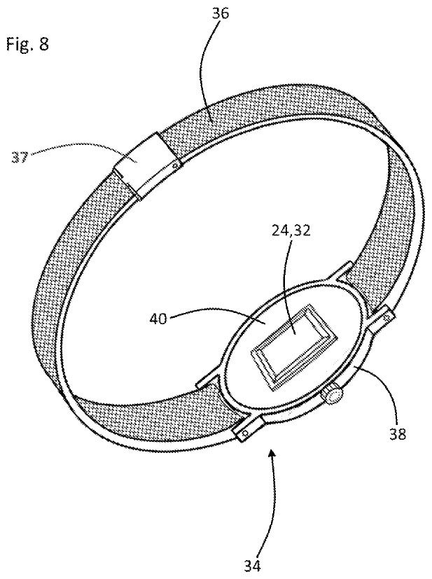

Referring simultaneously to FIGS. 6 and 8, a wristwatch 34 having a loop 36 and a fastener 37, constitutes one of the above referenced alternatives to the bracelet configuration 19, the watch portion 38 of such wristwatch 34 having an RFID tag applique assembly 24,32 mounted upon its undersurface or back 40. The bracelet 19 of FIG. 6, and the wristwatch 34 of FIG. 8 are intended as being further representative of other types of jewelry which may be worn at or about a user's hands, fingers, and wrists, which include an internally embedded or integrally formed micro RFID tag.

Referring simultaneously to FIGS. 1, 5, 8, and 9, an exemplary user of the instant inventive system is referred to generally by Reference Arrow 42, such user 42 wearing the wristwatch 34 about her right wrist 39. Prior to or contemporaneously with donning the wristwatch 34, the user 42 may release the clasp 4 of the RFID ready necklace 1, and may encircle such necklace about her neck 44, the user reattaching clasp 4 at the back of her neck 44.

Thereafter, the user 42 may depress power button 10 in order to actuate the electronic RFID reader microcircuitry which is housed within case 6. Upon such actuation, such reader component 6 continuously emits interrogating radio waves which are adapted to interact with a passive RFID tag 32 which is housed within applique 24 and which is adhesively mounted to the undersurface 40 of the watch 38. The bracelet 19 of FIG. 6 having a second passive RFID tag mounted to its undersurface may suitably be worn upon such user's left wrist (not shown within views).

Upon movement of such watch 38 and attached RFID tag assembly 24 through the interrogating radio waves emitted by the reader unit 6, electrical power is induced within the RFID tag 32, temporarily electrically powering such tag. Upon the provision of such magnetically induced electric power within the RFID tag 32, such tag acts as a transponder in the generation and transmission of a returning data signal which is received and acted upon by the RFID reader 6. Such data is interpreted by integrated circuitry of the RFID reader 6 to actuate either the speaker 12 and/or an electronic vibrator housed within the case.

As indicated in FIG. 9, an actuated auditory signal 7 may be heard by the person 42 prior to the occurrence of any contact by the fingers of her hand 48 with her face 46. Such auditory signal advantageously reminds the person 42 to avoid touching her face with her fingers.

The necklace configured RFID reader half 1 of the instant inventive system is intended as being representative of other types of jewelry and clothing items which are traditionally worn at or about a user's head or neck, such as necklace pendants, brooches, pins which may be attached to headbands or hatbands, bolo tie ornaments, earrings, and scarf clasps.

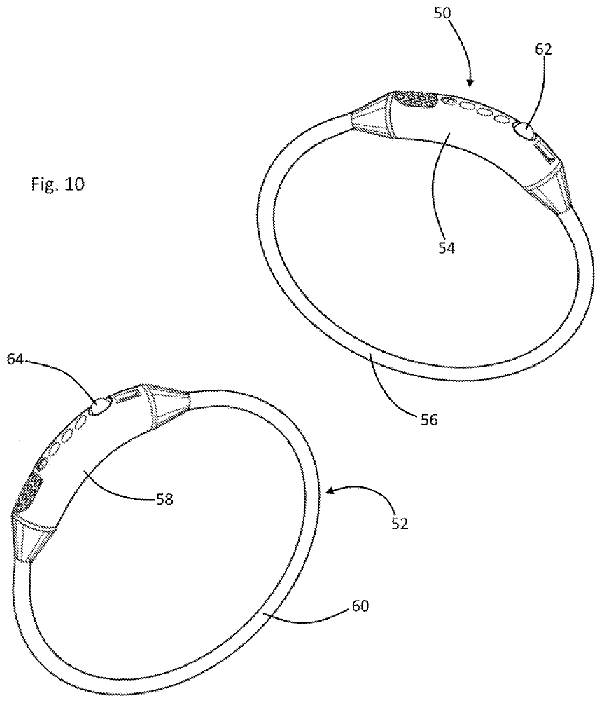

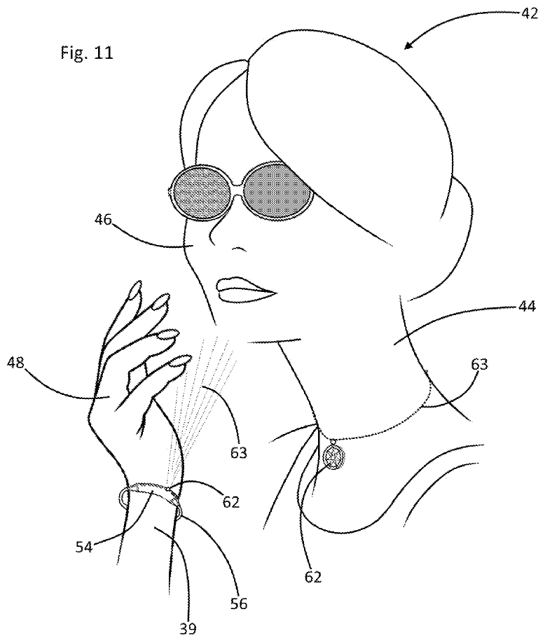

As indicated in FIG. 10, the RFID reader component of the instant inventive assembly may be further alternatively configured as a pair of bracelets 50 and 52, such bracelets having incorporated hollow electronic component cases 54 and 58. Suitably, loop components 56 and 60 of such bracelet configured RFID reader units 50 and 52 may be flexible and elastomeric for close fitting about, referring further to FIG. 11, a user's wrists 39. Similarly with the necklace configured RFID reader unit 1, cases 54 and 58 include electronic speakers and/or internal electronic vibrating units.

Such smaller cases which are worn at a user's wrists may advantageously incorporate LED lights 62 and 64 for generating a visual warning signal 63. Where such bracelet configured RFID units 50 and 52 are provided, the system's passive RFID tag (such as applique assembly 24,32) may be mounted upon, for example, the reverse side of a pendant 62 worn about the user's neck 44 upon a chain 63. Upon actuation of the wrist mounted RFID readers 50 and 52, and upon relative movement of the pendant 62 within an interrogating radio wave generated by one of the readers, 50 or 52, a magnetic induction generated return radio signal actuates such reader unit. Data communicated via the return signal electronically triggers an emission of, for example, a visual signal 63 emitted by LED bulb 62. Alternatively, bracelet mounted speakers or vibrators may be selected and actuated to emit an audible warning signal or a vibratory signal.

While the passive tag RFID system described above constitutes a preferred mode and configuration of the instant invention, both of the halves of the inventive assembly which are worn at a user's hand/wrist zone and at the user's head/neck zone, may constitute an electric battery powered system half or component. Where both of the halves of the instant invention are battery powered, the system constitutes an active tag RFID system which beneficially powers the RFID tag or tags with an electric battery. As an additional benefit, the active tag configuration provides redundancy of the system's power supply.

While the principles of the invention have been made clear in the above illustrative embodiment, those skilled in the art may make modifications in the structure, arrangement, portions and components of the invention's assembly without departing from those principles. Those skilled in the art may also modify the invention's method steps including changes to their identity, character, and sequence of performance without departing from those principles. Accordingly, it is intended that the description and drawings be interpreted as illustrative and not in the limiting sense, and that the invention be given a scope at least commensurate with the appended claims.

The invention hereby claimed is:

1. An assembly for warning of hand to face contacts, said assembly comprising:
(a) a radio frequency identification system reader;
(b) a case supporting or containing the radio frequency identification system reader, the case being configured as a wearable item selected from the group consisting of necklace segments, necklace pendants, brooches, pins, scarves, headbands, hats, clasps, earrings, hair ornaments, and tie slides;
(c) a first jewelry item selected from a group consisting of bracelets, wristwatches, and rings; and
(d) a first radio frequency identification system data signaling tag, said tag being fixedly attached to the first jewelry item.

2. The assembly of claim 1 comprising a second radio frequency identification system tag, and further comprising a second jewelry item selected from the group consisting of bracelets, wristwatches, and rings, said second radio frequency identification system tag being fixedly attached to said second jewelry item.

3. The assembly of claim 2 wherein the radio frequency identification system reader comprises an active reader half of an active reader passive tag radio frequency identification system.

4. The assembly of claim 3 wherein the radio frequency identification system reader is adapted for continuous transmission of an interrogator radio signal.

5. The assembly of claim 4 wherein the radio frequency identification system reader is further adapted for receiving radio signal replies generated in response to the interrogator radio signal transmissions.

6. The assembly of claim 5 wherein the radio frequency identification system reader is further adapted to transmit approximately thirteen megahertz interrogator radio signals.

7. The assembly of claim 6 wherein the case further supports or contains RFID system components selected from the group consisting of rechargeable batteries, USB charging ports, digital micro-processors, radio transmitters, radio receivers, antennas, electronic vibrating units, electronic buzzers, speakers, LED lamps, voice synthesizing micro-circuitry, and on/off switches.

8. The assembly of claim 7 wherein each radio frequency identification system signaling tag comprises a digital data packet transmitting transponder.

9. The assembly of claim 8 wherein each radio frequency identification system signaling tag is adapted for magnetic induction electric power.

10. The assembly of claim 8 wherein each radio frequency identification system signaling tag is electrically powered by a battery.

11. The assembly of claim 8 wherein each jewelry item in the groups consisting of bracelets, wristwatches, and rings has an undersurface, and wherein the fixed attachment of each radio frequency identification system data signaling tag positions said each tag upon one of said undersurfaces.

12. The assembly of claim 11 further comprising a pair of retainer appliques, each retainer applique being fitted for receiving the one of the radio frequency identification system data signaling tags, said each applique securely holding said one of the tags upon the selected jewelry item's undersurface.

13. An assembly for warning of hand to face contacts, said assembly comprising:
(a) a pair of radio frequency identification system readers;
(b) a pair of cases supporting or containing the radio frequency identification system readers, each case being configured as a ring or a bracelet;
(c) a wearable item selected from a group consisting of necklace segments, necklace pendants, brooches, earrings, pins, scarves, headbands, hats, clasps, hair ornaments, and tie slides; and
(d) a radio frequency identification system data signaling tag, said tag being fixedly attached to the wearable item.

14. The assembly of claim 13 wherein each radio frequency identification system reader comprises an active reader half of an active reader passive tag radio frequency identification system.

15. The assembly of claim 14 wherein each radio frequency identification system reader is adapted for continuous transmission of an interrogator radio signal.

16. The assembly of claim 15 wherein each radio frequency identification system reader is further adapted for receiving radio signal replies generated in response to the interrogator radio signal transmissions.

17. The assembly of claim 16 wherein each radio frequency identification system reader is further adapted to transmit approximately thirteen megahertz interrogator radio signals.

18. The assembly of claim 17 wherein each case further supports or contains RFID system components selected from the group consisting of rechargeable batteries, USB charging ports, digital micro-processors, radio transmitters, radio receivers, antennas, electronic vibrating units, electronic buzzers, speakers, LED lamps, voice synthesizing micro-circuitry, and on/off switches.

19. A method for warning of a contact by a person's hand with the person's face, said method comprising steps of:
(a) providing a radio frequency identification system reader which is adapted for transmitting an interrogator radio signal, which is further adapted for receiving a RFID radio signal reply, and which is adapted for actuating an auditory, vibrating, or visual output upon the receipt of the radio signal reply;
(b) enclosing the radio frequency identification system reader within a case which is configured as a wearable item selected from the group consisting of necklace segments, necklace pendants, brooches, pins, hair ornaments, earrings, hats, clasps, and tie slides;
(c) actuating the radio frequency identification system reader and donning the selected wearable item so that the radio frequency identification system reader is in close proximity with the person's face;
(d) providing a first radio frequency identification system data signaling tag;
(e) providing a first jewelry item selected from the group consisting of bracelets, wristwatches, and rings, and fixedly attaching the first radio frequency first identification system data signaling tag to said jewelry item;
(f) donning the first jewelry item upon the person's wrist or hand;
(g) moving the wrist or hand, the first jewelry item and the first radio frequency identification system data signaling tag toward the person's face, such motion carrying said tag through the interrogator radio signal;
(h) generating a data radio signal in response to said tag's motion through the interrogator radio signal;
(I) receiving the generated data radio signal at the radio frequency identification system reader; and
(j) actuating said reader's audio, vibratory, or visual output in response to said reader's receipt of the radio data signal.

20. The method of claim 19 comprising steps of providing a second radio frequency identification system data signaling tag; providing a second jewelry item selected from the group consisting of bracelets, wristwatches, and rings, wherein said second data signaling tag is fixedly attached to said second jewelry item; donning the second jewelry item upon the person's other wrist or other hand; and alternatively moving said other wrist or other hand, second jewelry item and second data signaling tag toward the person's face.
